(19) United States
(12) Patent Application Publication
(10) Pub. No.: US 2007/0103080 A1
(43) Pub. Date: May 10, 2007

(54) Glass sealing and electric lamps with such sealing

(76) Inventors: Zoltan Bako, Nyereg koz (HU); Zsuzsanna Varga, Venetianer u (HU)

Correspondence Address: FAY SHARPE LLP, 1100 SUPERIOR AVENUE, SEVENTH FLOOR, CLEVELAND, OH, 44114, US

(21) Appl. No.: 11/270,415

(22) Filed: Nov. 9, 2005

(51) Int. Cl. H01J 61/36; H01J 17/18

(52) U.S. Cl. 313/623; 313/624; 313/625

(57) ABSTRACT

A glass sealing and electric lamps with such sealing are provided. The lamp is comprised of a sealing glass body, lead-in wires passing through the sealing glass body, a high electric resistance glass layer encapsulating each of the lead-in wires and separating them from the sealing glass body. The high electric resistance glass layer is joined both with the lead-in wires and with the sealing glass body in a manner providing hermetic closure of the glass sealing.

### BACKGROUND OF THE INVENTION

This invention relates to a glass sealing structure of electric lamps, more particularly to a hermetic sealing between the internal chamber of the lamps and the environment. The invention also relates to lamps manufactured with such sealing.

High electric resistance lead glasses are used to manufacture parts for hermetic sealing and electric insulation in electric lamps. Lead-free glasses have recently replaced lead glasses due to environment protection requirements.

U.S. Pat. No. 5,391,523 discloses several lamp constructions using high electric resistance lead-free glass compositions with specified SiO₂ matrix as sealing glass. The sealing parts and the stem or mount of lamps are made of the lead-free glass compositions. In case of wedge-base lamps, the entire bulb or envelope is made of lead-free glass composition.

U.S. Pat. No. 3,723,790 discloses electric articles such as electric lamps and electric tubes having dumet current conductors and a glass enclosure sealed to the conductors. Dumet wire is a known type of wire employed in the production of electrical conductors, composed of a nickel-iron alloy core portion and a copper coating on external portion. The copper coating is designed to absorb stresses that may develop during the sealing operation. There are different dumet metals, depending on the particular composition of the core alloy. The glass enclosure and the stem are composed entirely of a specified electric sealing glass composition and may be composed of a soda lime glass envelope joined to the conductors with the electric sealing glass stem as intermediate components.

In the constructions described in the patents above, the entire volume of the sealing glass part such as the entire envelope or the stem was made of expensive high electric resistance glass composition. This feature involves a glass composition of high lead content or equivalent insulating lead-free glasses, but both are considerably more expensive than the common soda lime glass.

There is a particular need for decreasing the cost of material used for manufacturing glass parts of electric lamps. At the same time high electric resistance between the lead-in wires is required to be maintained.

### SUMMARY OF THE INVENTION

In an exemplary embodiment of the invention, a glass sealing for electric lamps is comprised of a sealing glass body, lead-in wires passing through the sealing glass body, a high electric resistance glass layer encapsulating each of the lead-in wires and separating them from the sealing glass body. The high electric resistance glass layer is joined both with the lead-in wires and with the sealing glass body in a manner providing hermetic enclosure of the glass sealing.

In an exemplary embodiment of another aspect of the invention, an electric lamp is comprised of an envelope, a stem and a glass sealing determined above. The sealing glass body is integral with the stem of the electric lamp and the stem is joined to the envelope.

In an exemplary embodiment of a further aspect of the invention, an electric lamp is comprised of an envelope and a glass sealing determined above. The sealing glass body is integral with the envelope of the electric lamp.

The glass sealing proposed has several advantages over the prior art. It was found that only a thin layer of expensive high electric resistance glass material is required for suitable electric insulation between the lead-in wires of the lamps. A thin layer of high electric resistance glass allows the use of low cost glass compositions as sealing glass material in lamp constructions consisting of soft glasses. The required volume of the low cost sealing glass is much higher than that of the high electric resistance glass of thin layer. In case of lamps, in which the glass part is made of one glass composition, such as wedge-base lamps, the glass part can be made of low cost glass, such as soda lime glass, instead of expensive lead-free or lead glass materials. In lamps consisting of envelope and stem, both the envelope and the stem can be made of low cost glass material such as soda lime glass.

### BRIEF DESCRIPTION OF DRAWINGS

The invention will now be described with reference to enclosed drawings where:

FIG. 1 shows a cross section of a glass sealing,

FIG. 2 shows an automotive lamp having a stem with the glass sealing of FIG. 1, partly in longitudinal cross section,

FIG. 3 shows a wedge-base glass lamp having an envelope, in which the glass sealing of FIG. 1 is formed by a part of the envelope,

FIG. 4 shows a festoon lamp having an envelope with the glass sealing of FIG. 1.

FIG. 5 shows a common incandescent lamp having a stem with the glass sealing of FIG. 1.

### DETAILED DESCRIPTION OF THE INVENTION

In the context of this invention, the term glass sealing is used as a part of a lamp structure for hermetic enclosure between atmospheric environment and lamp internal chamber. The glass sealing can be connected to a glass envelope of a lamp or an envelope of a lamp can be formed integrally with the glass sealing.

In electric lamps consisting of soft glasses such as incandescent lamps, fluorescent lamps, low wattage high intensity discharge lamps and wedge-base lamps, lead glass or high electric resistance lead-free glass is used to make parts, such as pinching or sealing, which encapsulate the lead-in wires.

Essential reason for the application of these high electric resistance glasses is to provide proper glass-to-metal sealing that prohibits air leakage into the lamp. The electric potential difference between the lead-in wires causes ion movement, primarily alkali ions movement, which results in composition change by electrolysis on the metal surface of the lead-in wires and in the surrounding glass area. The specific thermal expansion altered by the change of composition results in expansion mismatch between the lead-in wires and the glass. The expansion mismatch leads to cracks and air leakage in the lamps. Alkali ion movement appears particularly in lamps driven by DC voltage, but this ion movement also appears in lamps, to which AC voltage is applied. Electric insulation property of the material surrounding the lead-in wires is required to decrease ion movement. For the electric insulation and the proper glass-to-metal sealing, lead glass or high electric resistance lead-free glass is used.

Turning now to FIG. 1, a cross section of a glass sealing 1 is shown. Lead-in wires 5 are implicated in a sealing glass body 4 in such a way that a high electric resistance glass layer 6 is used between the lead-in wires 5 and the sealing glass body 4, and the high electric resistance glass layer 6 encapsulates the part of the corresponding lead-in wire 5, which passes through the material of the sealing glass body 4. The thickness of the high electric resistance glass layer 6 is at least 10 microns, it is preferably in the range of 10-500 microns, and the value of Tₖ₁₀₀ exceeds 220° C., preferably Tₖ₁₀₀ is more than 270° C. Tₖ₁₀₀ is the temperature, at which the specific electric resistance is equal to 10⁸ Ohm cm according to the standard ASTM C 657-72(1).

The thickness of the glass layer 6 and its thermal expansion coefficient are selected or adjusted so that a crack-free cooperation of the sealing body 4 and the glass layer 6 is accomplished. For this purpose, the thermal expansion coefficient of the glass layer 6 is in the range of 85-115 10⁻⁷ 1/K. The crack-free cooperation may be more likely if the thermal expansion coefficient is in the range of 90-110 10⁻⁷ 1/K.

The high electric resistance glass layer 6 can be deposited on the lead-in wires 5 or it can be pulled over the lead-in wires 5 in the form of low diameter tube. The thickness of the tube wall, which is the thickness of the high electric resistance glass layer 6, can be in the range of 100-500 microns for example. In order to provide a sufficient electric resistance in the entire region around the lead-in wires, the deposited covering layer has to be at least 10 microns thick. The deposited glass layer 6 or pulled over tube is melted to the lead-in wires 5 and to the sealing glass body 4 both for providing hermetic enclosure of the glass sealing 1.

The material for high electric resistance glass layer 6 can be selected from a wide range of glass materials, preferably of SiO₂ matrix lead-free glass material.

Dumet is a structured material composition frequently used for configuring lead-in wires 5. The dumet has a structure of FeNi core, Cu layer and Cu₂O layer. In special cases, a Ni layer is additionally applied to the surface of the dumet. In one embodiment of the invention, the high electric resistance glass layer 6 is deposited on the surface of dumet lead-in wires 5.

Depending on manufacturing and working conditions of electric lamps, the sealing glass body 4 can be made of several different glass materials. For most of the lamp constructions, soda lime glass is an economic and well-known selection for the material of the sealing glass body 4.

In the prior art, sealing part of an envelope or a stem of a lamp plays dual role: hermetic sealing and electric insulation. In the embodiments of this invention, an envelope or a stem as sealing glass body 4 has only one role: hermetic sealing. The sealing glass body 4 serves as hermetic sealing of the lamp, while the high electric resistance glass layer 6 around the lead-in wires 5 provide both electric insulation and hermetic sealing.

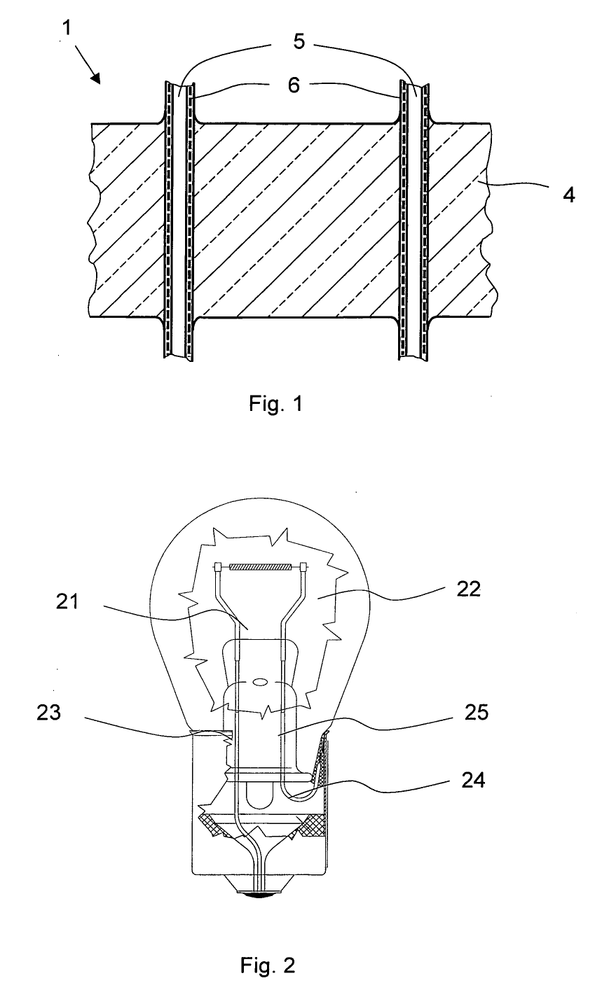

An incandescent automotive lamp built up with a stem made of the glass sealing can be seen in the FIG. 2. In case of this embodiment of the invention, the lamp structure is similar to well-known automotive incandescent lamps with some differences in the sealing configuration. A stem 24 is melted together with an envelope 22 and lead-in wires 23, 25 are embedded in the stem 24. A filament 21 is connected to the lead-in wires 23, 25. The difference is that a SiO₂ matrix high electric resistance glass layer is deposited onto the lead-in wires 23, 25. The glass material of the stem 24 can be identified as the sealing glass body 4 therefore both the stem 24 and the envelope 22 can be made of cheap soda lime glass material.

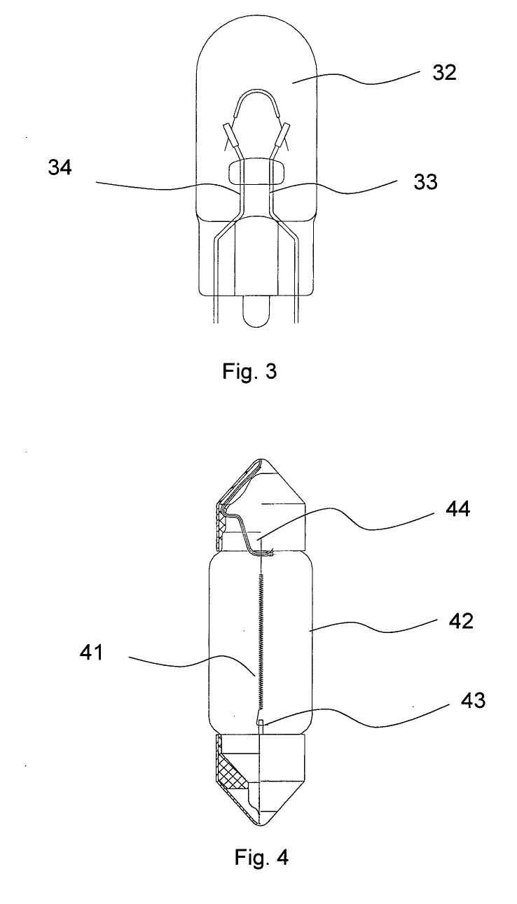

In FIG. 3, as a further embodiment of the invention, a wedge-base glass lamp with a bulb tube 32 with the glass sealing of FIG. 1 is shown. Lead-in wires 33, 34 are encapsulated with SiO₂ matrix high electric resistance glass layer. The bulb tube 32 is melted together with the layer melted onto the surface of the lead-in wires 33, 34. The bulb tube 32 actually forms the sealing glass body made of economic soda lime glass. In other words, the sealing glass body 4 is integral with the bulb tube 32.

A festoon lamp as a further embodiment of the invention is shown in FIG. 4. Substantial difference between the lamp constructions above and the festoon lamp is that the festoon lamp has two base members jointed to a glass tube. Lead-in wires 43, 44 are connected to the internal surface of the base members. Between the two lead-in wires 43, 44, a filament 41 is jointed to their ends. The lead-in wires 43, 44 are led through both the opposite ends of the glass tube 42. In case of this embodiment of the invention, a deposited SiO₂ matrix high electric resistance glass layer covers the lead-in wires 43, 44 or at least the corresponding passing through parts of them. The glass tube 42 and the deposited lead-in wires 43, 44 are melted together for providing hermetic sealing of the lamp. The material of the glass tube 42 is cheap soda lime glass.

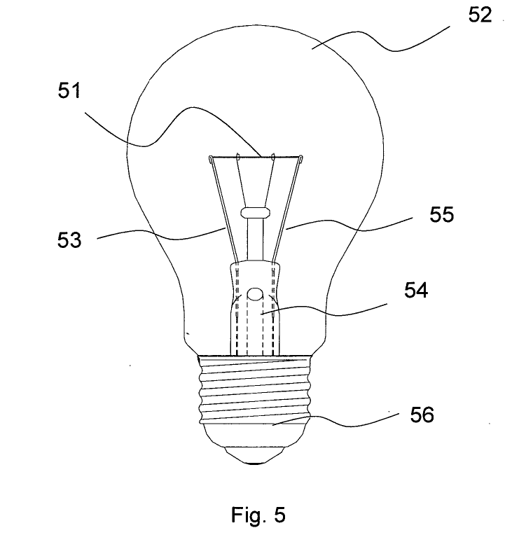

As a further possible embodiment of the invention, a commonly used incandescent lamp of FIG. 5 is constructed with a stem 54 and an envelope 52 both made as a part of an integral glass structure including the sealing glass body, which latter is protruding into an Edison-type lamp base 56 in FIG. 5. The lamp structure is also comprises lead-in wires 53, 55 passing through the sealing glass body. The stem 54 is melted together with the envelope 52, while the lead-in wires 53, 55 covered by the encapsulating high electric resistance glass layer are embedded in the stem 54. In other words, the sealing glass body is integral with the stem 54. A filament 51 is connected to one ends of the lead-in wires 53, 55 within the envelope 52, while the other ends of the lead-in wires 53, 55 are connected to the lamp base 56.

The invention can be adapted for any other kind of lamps having lead-in wires. The economic aspect results in a much less quantity of expensive special glass to be used for manufacturing and this is a substantial advantage in any field of the lighting industry.

1. A glass sealing for electric lamps comprising a sealing glass body, lead-in wires passing through the sealing glass body, a high electric resistance glass layer encapsulating each of the lead-in wires and separating them from the sealing glass body, the high electric resistance glass layer being joined both with the lead-in wires and with the sealing glass body in a manner providing hermetic closure of the glass sealing.

2. The glass sealing of claim 1, in which the high electric resistance glass layer has a thickness of at least 10 microns.

3. The glass sealing of claim 2, in which the thickness of the high electric resistance glass layer is in the range of 10-500 microns.

4. The glass sealing of claim 1, in which the high electric resistance glass layer is in the form of a tube pulled over each of the lead-in wires.

5. The glass sealing of claim 4, in which the tube has a wall thickness in the range of 100-500 microns.

6. The glass sealing of claim 1, in which the high electric resistance glass layer has a Tₖ₁₀₀ value exceeding 220° C.

7. The glass sealing of claim 6, in which the high electric resistance glass layer has a Tₖ₁₀₀ value exceeding 270° C.

8. The glass sealing of claim 1, in which the high electric resistance glass layer has a thermal expansion coefficient in the range of 85-115 10⁻⁷ 1/K.

9. The glass sealing of claim 8, in which the thermal expansion coefficient of the high electric resistance glass layer is in the range of 90-110 10⁻⁷ 1/K.

10. The glass sealing of claim 1, in which the high electric resistance glass layer is deposited on the lead-in wires.

11. The glass sealing of claim 1, in which the high electric resistance glass layer is made of a SiO₂ matrix lead-free glass material.

12. The glass sealing of claim 1, in which the lead-in wires have a structure of FeNi core, Cu layer and Cu₂O layer.

13. The glass sealing of claim 12, in which an additional Ni layer is applied to a surface portion of the lead-in wires.

14. The glass sealing of claim 1, in which the sealing glass body is made of soda lime glass.

15. An electric lamp with glass sealing, the lamp comprising an envelope, a stem, a sealing glass body, lead-in wires passing through the sealing glass body, a high electric resistance glass layer encapsulating each of the lead-in wires and separating them from the sealing glass body, the high electric resistance glass layer being joined both with the lead-in wires and with the sealing glass body in a manner providing hermetic closure of the glass sealing, and the sealing glass body being integral with the stem of the electric lamp, and the stem being joined to the envelope.

16. The electric lamp of claim 15, in which the stem is made of soda lime glass.

17. The electric lamp of claim 15, in which the envelope is made of soda lime glass.

18. The electric lamp of claim 15, in which the high electric resistance glass layer has a thickness of at least 10 microns.

19. The electric lamp of claim 18, in which the thickness of the high electric resistance glass layer is in the range of 10-500 microns.

20. The electric lamp of claim 15, in which the high electric resistance glass. layer is in the form of a tube of a wall thickness in the range of 100-500 microns.

21. The electric lamp of claim 15, in which the high electric resistance glass layer has a Tₖ₁₀₀ value exceeding 220° C.

22. The electric lamp of claim 21, in which the high electric resistance glass layer has a Tₖ₁₀₀ value exceeding 270° C.

23. The electric lamp of claim 15, in which the high electric resistance glass layer has thermal expansion coefficient in the range of 85-115 10⁻⁷ 1/K.

24. The electric lamp of claim 23, in which the thermal expansion coefficient of the high electric resistance glass layer is in the range of 90-110 10⁻⁷ 1/K.

25. The electric lamp of claim 15, in which the high electric resistance glass layer is deposited on the lead-in wires.

26. An electric lamp with glass sealing, the lamp comprising an envelope, a sealing glass body, lead-in wires passing through the sealing glass body, a high electric resistance glass layer encapsulating each of the lead-in wires and separating them from the sealing glass body, the high electric resistance glass layer being joined both with the lead-in wires and with the sealing glass body in a manner providing hermetic closure of the glass sealing, and the sealing glass body being integral with the envelope of the electric lamp.

27. The electric lamp of claim 26, in which the envelope is made of soda lime glass.
